(19) United States
(12) Patent Application Publication
(10) Pub. No.: US 2022/0163798 A1
(43) Pub. Date: May 26, 2022

(54) LUMINANCE ADJUSTMENT SYSTEM AND DISPLAY SYSTEM FOR DISPLAYING VIRTUAL IMAGE

(71) Applicant: Panasonic Intellectual Property Management Co., Ltd., Osaka (JP)

(72) Inventor: Satoshi MIKAYAMA, Kanagawa (JP)

(73) Assignee: Panasonic Intellectual Property Management Co., Ltd., Osaka (JP)

(21) Appl. No.: 17/532,631

(22) Filed: Nov. 22, 2021

(30) Foreign Application Priority Data
Nov. 26, 2020 (JP) 2020-196280

(51) Int. Cl. G02B 27/01; B60K 37/02

(52) U.S. Cl. CPC G02B 27/0101; B60K 37/02; G02B 2027/0118; B60K 2370/52; B60K 2370/1529; B60K 2370/25; B60Y 2200/11

(57) ABSTRACT

A first filter transmits a portion of incident light that has a first dominant wavelength. A second filter transmits a portion of incident light that has a second dominant wavelength different from the first dominant wavelength. An illuminance detector detects a first illuminance of light transmitted through a first filter and a second illuminance of light transmitted through a second filter. A controller adjusts the luminance of an image display on a display device according to the first illuminance and the second illuminance detected by the illuminance detector.

### BACKGROUND

### 1. Field

The present disclosure relates to display technology and particularly to a luminance adjustment system and a display system for displaying virtual images.

### 2. Description of the Related Art

A display device (HUD: Head-Up Display) superimposes the outside view through the windshield of a vehicle with a virtual image representing an image for route guidance, etc., for visual recognition by the driver of the vehicle. Further, in order to provide a clear virtual image to the driver, the HUD is required to have a function of adjusting the luminance of the image to be displayed in accordance with the brightness of the outside light from the surrounding environment. For example, in the prior art, a case has been studied where the headlight of an oncoming vehicle at night makes it difficult to see a virtual image from the HUD (see, for example, Patent Literature 1). According to Patent Literature 1, the contrast of a virtual image from an HUD is secured by adjusting the luminance of the virtual image according to an angle formed by a high-luminance region, which is a region consisting of one or more points and exhibiting luminance that is higher than the average luminance of each point, and a reference direction in an acquired luminance distribution.

[Patent Literature 1] Japanese Patent Application Publication NO. 2019-159216

In Patent Literature 1, the luminance of a virtual image is increased according to a high-luminance region of the illuminance of the scenery in front. However, when the luminance of the virtual image is increased, the boundary of the illumination range of the virtual image may become visible according to the dominant wavelength of the scenery in front even when the illuminance is the same.

### SUMMARY

In this background, a purpose of the present disclosure is to provide a technology for adjusting the luminance of an image display according to the dominant wavelength of the scenery in front.

A luminance adjustment system according to one aspect of the present disclosure includes: a first filter that transmits a portion of incident light that has a first dominant wavelength; a second filter that transmits a portion of the incident light that has a second dominant wavelength different from the first dominant wavelength; an illuminance detector that detects a first illuminance of light transmitted through the first filter and a second illuminance of light transmitted through the second filter; and a controller that adjusts the luminance of an image display on a display device according to the first illuminance and the second illuminance detected by the illuminance detector.

Another aspect of the present disclosure relates to a display system. This display system includes: a display device that is mountable in a vehicle; and a luminance adjustment system that adjusts the luminance of an image display on the display device. The luminance adjustment system includes: a first filter that transmits a portion of incident light that has a first dominant wavelength; a second filter that transmits a portion of the incident light that has a second dominant wavelength different from the first dominant wavelength; an illuminance detector that detects a first illuminance of light transmitted through the first filter and a second illuminance of light transmitted through the second filter; and a controller that adjusts the luminance according to the first illuminance and the second illuminance detected by the illuminance detector.

Optional combinations of the aforementioned constituting elements, and implementations of the disclosure in the form of methods, apparatuses, systems, computer programs, or recording media recording computer programs may also be practiced as additional modes of the present disclosure.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a diagram showing the structure of a vehicle according to an embodiment;

FIGS. 2A-2B are diagrams showing a virtual image of FIG. 1;

FIG. 3 is a diagram showing the configuration of a display system of FIG. 1;

FIG. 4 is a diagram showing the configuration of an infrared light absorption filter and an illuminance sensor of FIG. 3;

FIG. 5 is a diagram showing the characteristics of a first filter and a second filter of FIG. 4; and

FIG. 6 is a diagram showing the data structure of a table stored in a storage of FIG. 3.

### DETAILED DESCRIPTION

The invention will now be described by reference to the preferred embodiments. This does not intend to limit the scope of the present invention, but to exemplify the invention.

Before a specific explanation of the present embodiment is given, an explanation will be given regarding knowledge on which the embodiment is based. The embodiment according to the present disclosure relates to a display system including a HUD that is mounted on a vehicle. The HUD is a virtual image display device that displays information as a virtual image in a field of view for driving through the windshield and supports driver's field of view information. For example, the HUD displays information on a liquid crystal panel or the like, causes the information to be reflected on a mirror, and projects the information on a windshield as a virtual image. To the driver, the image appears to be “floating” in front of the driver, rather than as a still image on the windshield.

Generally, it is considered that the higher the contrast ratio with respect to a video image, the higher the visibility of the image (Gish, KW, Staplin, Loren, “HUMAN FACTORS ASPECTS OF USING HEAD UP DISPLAYS IN AUTOMOBILES: A REVIEW OF THE LITERATURE. INTERIM REPORT”, Scientex Corporation, National Highway Traffic Safety Administration, 1995-8). With regard to a virtual image by a HUD, it is considered that the contrast ratio of the HUD shown below is desirably within a range of 1.15 to 1.5.

HUD contrast ratio=(display luminance+brightness of a landscape in front)/(ambient brightness)

This is because a virtual image display that is too bright for the brightness of a landscape in front reduces the visibility of the landscape in front. Meanwhile, it has been experimentally found that the desired contrast ratio differs between cloudy weather and clear weather. Therefore, when a display luminance setting suitable for clear weather is used in cloudy weather, the visibility of the landscape in front is lowered due to the emergence of an illumination range that is not visible in clear weather. It is assumed that this is because the dominant wavelength in the brightness of the landscape in front is different in clear weather and cloudy weather even when the illuminance is the same, and the contrast ratio of the virtual image is desirably adjusted according to the dominant wavelength.

The following embodiment is just one of various embodiments according to the present disclosure. The following embodiment can be variously modified according to the design and the like as long as the purpose of the present disclosure can be achieved. Further, each figure explained in the following embodiment is a schematic diagram, and the size ratio of each component in the figure does not necessarily reflect the actual dimensional ratio. Further, in the following explanation, “parallel” and “orthogonal” include not only a case of perfect parallelism and perfect orthogonality but also a case of being deviated from parallelism and orthogonality within the margin of error. In addition, “approximately” means being the same in an approximate range.

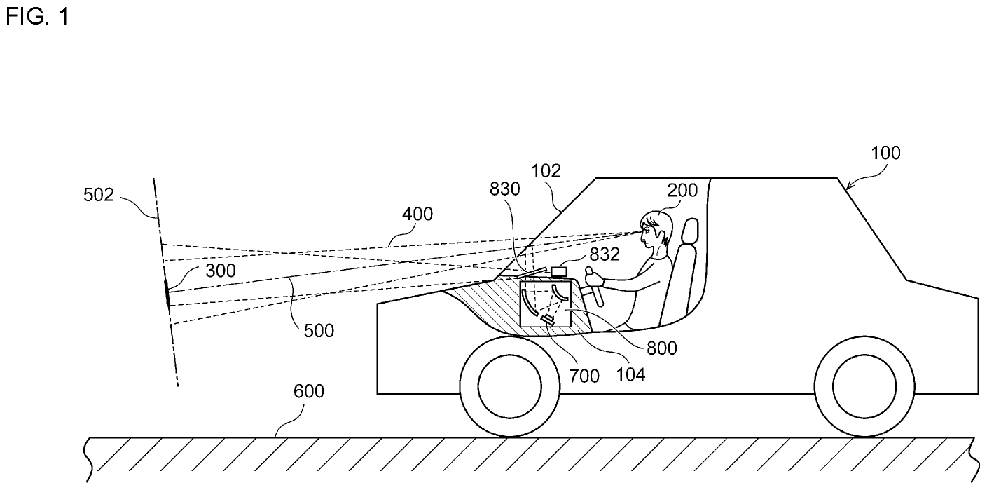

FIG. 1 shows the structure of a vehicle 100. The vehicle 100 as a moving object is equipped with a display system 700. The details of the display system 700 will be described later. The display system 700 includes a display device 800. In the present embodiment, it is assumed that the display device 800 is a HUD. However, the display device 800 is not limited to the HUD used for the vehicle 100 and can be applied to moving objects other than the vehicle 100 such as motorcycles, trains, aircraft, construction machinery, and ships. Further, the display device 800 is not limited to an HUD and may be an augmented reality (AR) display device that superimposes information on the real world. Further, the display device 800 may be a monitor for a side mirror (electronic mirror) of the vehicle 100, an instrument panel installed in the vehicle interior of the vehicle 100, a car navigation system, or the like.

The display device 800 is arranged in the vehicle interior of the vehicle 100, for example, in a dashboard 104 below a windshield 102 such that the display device 800 projects an image onto the windshield 102 of the vehicle 100 from below. A target space 400 in such an arrangement is a space outside the vehicle interior of the vehicle 100 and is mainly a space in front of the windshield 102 of the vehicle 100. On the other hand, when the display device 800 is a monitor installed in the vehicle interior, the target space 400 may be a space inside the vehicle interior of the vehicle 100. The target space 400 is, for example, a space including a region in which an image from the display device 800 is formed. The target space 400 does not have to include the image-forming region strictly and may include a peripheral region of the image-forming region.

The display device 800 forms a virtual image 300 on a virtual surface 502 that intersects an optical axis 500 of the display device 800. The optical axis 500 in the present embodiment is along a road surface 600 in front of the vehicle 100 in the target space 400 in front of the vehicle 100. The virtual surface 502 on which the virtual image 300 is formed is approximately perpendicular to the road surface 600. For example, when the road surface 600 is a horizontal plane, the virtual image 300 is displayed along the vertical plane.

Therefore, a user 200 who drives the vehicle 100 sees the virtual image 300 projected by the display device 800 and superimposed on the actual space spreading in front of the vehicle 100. Therefore, according to the display device 800, various types of driving support information such as vehicle speed information, navigation information, pedestrian information, front vehicle information, lane deviation information, vehicle condition information, and the like are displayed as a virtual image 300. Therefore, these pieces of information can be visually recognized by the user 200.

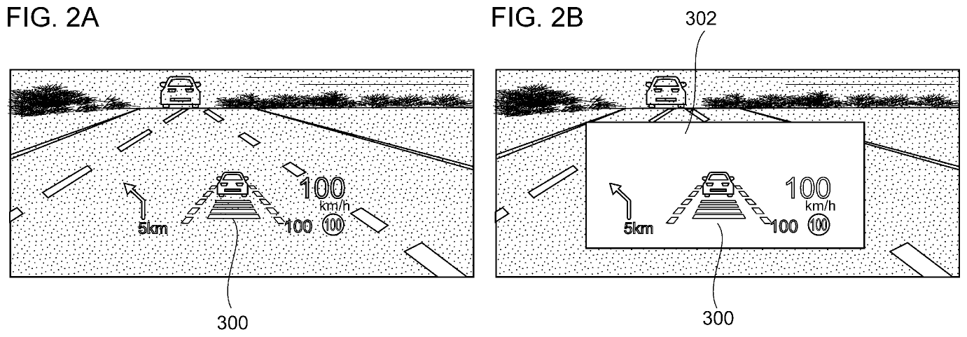

FIGS. 2A to 2B show a virtual image 300. FIG. 2A shows a virtual image 300 displayed in clear weather. The virtual image 300 shows, for example, information stating “100 km/h” as vehicle speed information. As a result, the user 200 visually acquires driving support information by only a slight movement of the line of sight from a state in which the line of sight is directed in the forward direction of the windshield 102. The luminance of the display device 800 for displaying the virtual image 300 is adjusted so as to be suitable in clear weather.

FIG. 2B shows a virtual image 300 displayed in cloudy weather. The illuminance in cloudy weather is approximately the same as the illuminance in clear weather in FIG. 2A. Therefore, the luminance of the display device 800 for displaying the virtual image 300 is set to the same value as in the case of FIG. 2A. As shown in FIG. 2B, the virtual image 300 is shown in a region 302 of white-tinged. The region 302 of white-tinged corresponds to the illumination range of the display device 800. Therefore, in the case of FIG. 2B, it can be considered that the luminance of the display device 800 for displaying the virtual image 300 is too high. On the other hand, when the luminance of the display device 800 for displaying the virtual image 300 is adjusted to be suitable for cloudy weather, the contrast ratio in the case of FIG. 2A becomes low, making the virtual image 300 difficult to see.

Comparing the case under clear weather and the case under cloudy weather, the dominant wavelength in cloudy weather is shorter than the dominant wavelength in clear weather. The dominant wavelength represents the value of a wavelength corresponding to a color actually seen with the eyes and represents the color and the wavelength that are sensuously associated with each other. That is, the shorter the dominant wavelength of the scenery in front becomes, the more likely the region 302 of white-tinged occurs. Therefore, it is not enough to adjust the luminance according to the illuminance of the scenery in front, and it is required to adjust the luminance according to the dominant wavelength of the scenery in front.

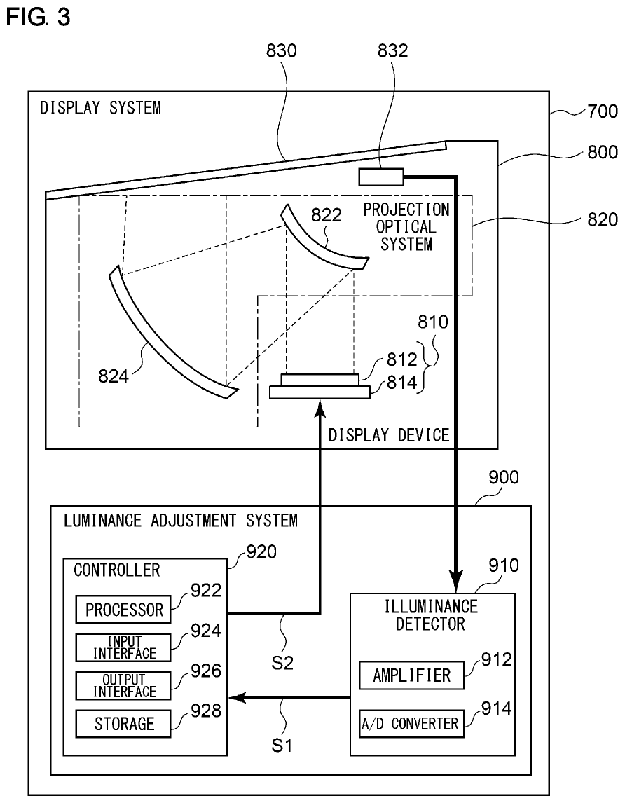

FIG. 3 shows the configuration of the display system 700. The display system 700 includes a display device 800 and a luminance adjustment system 900. The display device 800 includes an image formation interface 810, a projection optical system 820, an infrared light absorption filter 830, and an illuminance sensor 832. The image formation interface 810 includes a liquid crystal panel 812 and a light source device 814, and the projection optical system 820 includes a first mirror 822 and a second mirror 824. The luminance adjustment system 900 includes an illuminance detector 910 and a controller 920. The illuminance detector 910 includes an amplifier 912 and an A/D converter 914, and the controller 920 includes a processor 922, an input interface 924, an output interface 926, and a storage 928.

The image formation interface 810 outputs light that forms an image. The liquid crystal panel 812 is arranged in front of the light source device 814. The light source device 814 is a surface light source used as a backlight of the liquid crystal panel 812. The light source device 814 is a side light type light source that uses a solid-state light emitting element such as a light emitting diode or a laser diode. Light from the light source device 814 passes through the liquid crystal panel 812 and is output from the image formation interface 810. The luminance of the light source device 814 is adjusted by the luminance adjustment system 900 described later.

In the image formation interface 810, the light source device 814 emits light while an image is being displayed on the liquid crystal panel 812, thereby causing the light output in the forward direction from the light source device 814 to pass through the liquid crystal panel 812 and be output in the forward direction from the front surface of the liquid crystal panel 812. Since the light that is output from the front surface of the liquid crystal panel 812 in the forward direction reflects the image displayed on the liquid crystal panel 812, the light forming the image is output as “output light” from the image formation interface 810.

The longitudinal direction of the liquid crystal panel 812 is the longitudinal direction of a projected image, and the lateral direction of the liquid crystal panel 812 is the lateral direction of the projected image. The longitudinal direction of the projected image is the longitudinal direction of the virtual image 300 projected in the target space 400, that is, the direction along the vertical direction in the field of view of the user 200. The lateral direction of the projected image is the lateral direction of the virtual image 300 projected in the target space 400, that is, the direction along the horizontal direction in the field of view of the user 200.

The projection optical system 820 projects an image by reflecting the output light from the image formation interface 810. The projection optical system 820 is formed using a reflective member. Since the image is projected onto the windshield 102, the projection optical system 820 projects the image onto a target formed from the windshield 102.

The projection optical system 820 has, for example, a first mirror 822 and a second mirror 824. The first mirror 822 and the second mirror 824 are arranged in the order of the first mirror 822 and the second mirror 824 on the optical path of the light output from the image formation interface 810. In the present embodiment, the image formation interface 810, the first mirror 822, and the second mirror 824 are arranged at the vertex positions of a triangle formed in a vertical plane. The “vertical plane” referred to here is a plane that includes the longitudinal direction (vertical direction) of the image formed by the image formation interface 810 and the traveling direction (optical axis) of the output light. The projection optical system 820 reflects the output light from the image formation interface 810 by the first mirror 822, then reflects the output light by the second mirror 824, and emits the output light toward the windshield 102.

The first mirror 822 is arranged on the side opposite to the light source device 814 when viewed from the liquid crystal panel 812, that is, in front of the liquid crystal panel 812 such that the output light from the image formation interface 810 becomes incident. The first mirror 822 reflects the output light from the image formation interface 810 toward the second mirror 824. The second mirror 824 is arranged at a position where the output light from the image formation interface 810 reflected by the first mirror 822 becomes incident. The second mirror 824 reflects the output light from the image formation interface 810 reflected by the first mirror 822 from an opening of the dashboard 104 toward the windshield 102. For example, the first mirror 822 is a convex mirror, and the second mirror 824 is a concave mirror.

With such a configuration, the projection optical system 820 makes the image formed by the image formation interface 810 into an appropriate size and projects the image onto the windshield 102, which is the target, as a projected image so as to thereby project the virtual image 300 in the target space 400. The “virtual image” means an image formed as if an object were actually present by resulting divergent rays when light emitted from the display device 800 is diverged by a reflecting object such as the windshield 102.

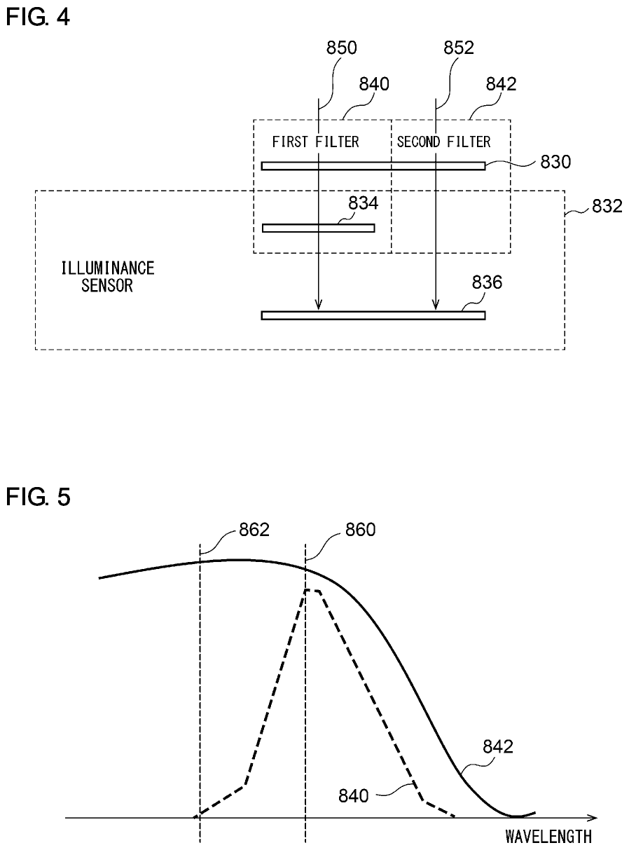

The infrared light absorption filter 830 closes the opening in the dashboard 104 of the vehicle 100. The light in the target space 400 passes through the infrared light absorption filter 830 and reaches the illuminance sensor 832. The illuminance sensor 832 includes, for example, a photodiode that detects the illuminance (brightness) in the target space 400 and is arranged near the opening in the dashboard 104 of the vehicle 100. The infrared light absorption filter 830 and the illuminance sensor 832 will be described in more detail with reference to FIGS. 4 and 5.

FIG. 4 shows the configuration of the infrared light absorption filter 830 and the illuminance sensor 832. The illuminance sensor 832 includes an optical filter 834 and a photodiode 836. Since the infrared light absorption filter 830 is a filter that absorbs light having a wavelength equal to or higher than the wavelength of infrared rays, the infrared light absorption filter 830 transmits light having a wavelength shorter than the wavelength of infrared rays. The optical filter 834 is a filter that transmits only visible light. The combination of the infrared light absorption filter 830 and the optical filter 834 is referred to as a first filter 840, and the infrared light absorption filter 830 is referred to as a second filter 842.

FIG. 5 shows the characteristics of the first filter 840 and the second filter 842. The horizontal axis indicates the wavelength. The first filter 840 has a characteristic of the combination of the infrared light absorption filter 830 and the optical filter 834 and transmits a portion of incident light that has a first dominant wavelength 860. The first dominant wavelength 860 is, for example, the wavelength of a green color. The second filter 842 has the characteristics of the infrared light absorption filter 830 and transmits a portion of incident light that has a second dominant wavelength 862. The second dominant wavelength 862 is, for example, the wavelength of a blue color. That is, the first dominant wavelength 860 is closer to the wavelength of a green color compared to the second dominant wavelength 862, and the second dominant wavelength 862 is closer to the wavelength of a blue color compared to the first dominant wavelength 860. For example, the first dominant wavelength 860 is 550 to 560 nm, and the second dominant wavelength 862 is 360 to 400 nm. FIG. 4 is referred back.

The incident light is separated into a first optical path 850 that passes through the first filter 840 and reaches the photodiode 836 and a second optical path 852 that passes through the second filter 842 and reaches the photodiode 836. The photodiode 836 detects an illuminance voltage according to the illuminance in the first optical path 850 and also detects an illuminance voltage according to the illuminance in the second optical path 852. When the incident light is yellow light having a dominant wavelength of 564 nm, the illuminance for the first optical path 850 is 70 lx, and the illuminance for the second optical path 852 is 80 lx. When the incident light is blue light having a dominant wavelength of 487 nm, the illuminance for the first optical path 850 is 70 lx, and the illuminance for the second optical path 852 is 90 lx.

The difference between the illuminance for the first optical path 850 and the illuminance for the second optical path 852 is larger in blue light than in yellow light. The yellow light is similar to incident light in clear weather, and the blue light is similar to incident light in cloudy weather. In other words, by evaluating the difference between the illuminance for the first optical path 850 and the illuminance for the second optical path 852, a situation in clear weather and a situation in cloudy weather can be separated. FIG. 3 is referred back. The illuminance sensor 832 outputs the illuminance voltage (analog signal) according to the illuminance for the first optical path 850 and the illuminance voltage according to the illuminance for the second optical path 852 to luminance adjustment system 900.

The luminance adjustment system 900 adjusts the luminance of an image display on the display device 800. For example, the luminance adjustment system 900 adjusts the brightness (luminance) of light output from the light source device 814, which is the backlight of the liquid crystal panel 812 in the display device 800. In particular, the illuminance detector 910 detects the illuminance in the target space 400 and outputs the detected illuminance to the controller 920. As described above, the target space 400 is a space including a region in which the image of the display device 800 is formed. In the present embodiment, the target space 400 is a space including a virtual image 300 on the virtual surface 502 outside the vehicle interior of the vehicle 100.

The amplifier 912 amplifies the signals input from the illuminance sensor 832 and outputs the amplified signals to the A/D converter 914. The A/D converter 914 converts the output signals from the amplifier 912 into digital signals and transmits the digital signals to the controller 920 as illuminance values (detection values). The signals input to the amplifier 912 are the illuminance voltage according to the illuminance for the first optical path 850 and the illuminance voltage according to the illuminance for the second optical path 852. Therefore, the illuminance values generated by the A/D converter 914 are the first illuminance value of the light transmitted through the first filter 840 and the second illuminance value of the light transmitted through the second filter 842.

The controller 920 adjusts the luminance of the image display on the display device 800 according to the first illuminance value and the second illuminance value detected by the illuminance detector 910. The controller 920 is composed of, for example, microcomputer having a central processing unit (CPU) and memory as main components. In other words, the controller 920 is realized by a computer having a CPU and memory, and the computer functions as the controller 920 by executing a program stored in the memory by the CPU. The program is pre-recorded in the memory of the controller 920 in this case. Alternatively, the program may be provided via a telecommunication line such as the Internet or being recorded in a recording medium such as a memory card.

The input interface 924 is electrically connected to the output end of the A/D converter 914 of the illuminance detector 910 via a signal line S1. The input interface 924 receives the first illuminance value and the second illuminance value from the illuminance detector 910.

The controller 920 derives a correction value c as follows based on a first illuminance value I₁ and a second illuminance value I₂.

c=((I₂−I₁)/I₁)×α

In this case, α is a constant for adjusting the correction value c and is determined by simulation calculation, an experiment, or the like.

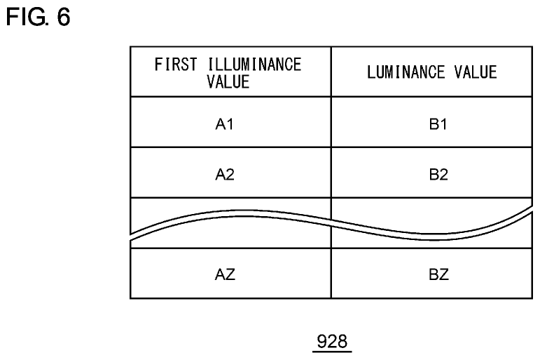

FIG. 6 shows the data structure of a table stored in the storage 928. The table shows the relationship between the first illuminance value and the luminance value. For example, the larger the first illuminance value, the larger the luminance value. FIG. 3 is referred back. The controller 920 derives the final luminance value L₂ as follows by correcting the luminance value L₁ acquired from the first illuminance value using the correction value c.

L₂=L₁×c

The output interface 926 is electrically connected to a lighting circuit that controls lighting of the light source in the light source device 814 via a signal line S2. The output interface 926 outputs a control signal generated by the processor 922 and showing the luminance value L₂ to the lighting circuit of the light source device 814. The light source device 814 receives the control signal, and the lighting circuit changes the light output of the light source so as to achieve the luminance value L₂ included in the control signal.

As described above, when the incident light is yellowish green light having a dominant wavelength of 564 nm, the illuminance for the first optical path 850 is 70 lx, and the illuminance for the second optical path 852 is 80 lx. When α is 0.5, the correction value c is 0.0715. This corresponds to reducing the luminance value by about 7 percent by correction. On the other hand, when the incident light is blue light having a dominant wavelength of 487 nm, the illuminance for the first optical path 850 is 70 lx, and the illuminance for the second optical path 852 is 90 lx. When α is 0.5, the correction value c is 0.143. This corresponds to reducing the luminance value by about 14 percent by correction. In this way, the controller 920 reduces the luminance value L₂ as the difference between the first illuminance value I₁ and the second illuminance value I₂ increases. This corresponds to a reduction in the luminance value when the incident light is blue light as compared with a case where the incident light is yellow light. In other words, the luminance value is reduced in cloudy weather rather than in clear weather.

The configuration is implemented in hardware by any central processing unit (CPU) of a computer, memory or other large scale integration (LSI), and in software by a program or the like loaded into the memory. The figure depicts functional blocks implemented by the cooperation of hardware and software. Thus, a person skilled in the art should appreciate that there are many ways of accomplishing these functional blocks in various forms in accordance with the components of hardware only or the combination of hardware and software.

According to the embodiment of the present disclosure, since the luminance is adjusted based on the illuminances of portions of light having different dominant wavelengths, the luminance of the image display can be adjusted according to the dominant wavelengths. Further, since the first dominant wavelength is set to be close to the wavelength of a green color and the second dominant wavelength is set to be close to the wavelength of a blue color, it is possible to set luminance that is suitable for each occasion of clear weather and cloudy weather. Further, since the luminance suitable for each occasion of clear weather and cloudy weather is set, it is possible to prevent the occurrence of apparent black predominance in cloudy weather while ensuring the contrast ratio obtained in clear weather. In addition, since the occurrence of apparent black predominance in cloudy weather is prevented while ensuring the contrast ratio obtained in clear weather, the visibility of the virtual image can be ensured. Further, since the luminance is reduced as the difference between the first illuminance and the second illuminance becomes larger, the luminance can be reduced in cloudy weather.

The outline of one aspect of the present disclosure is as follows. A luminance adjustment system according to one aspect of the present disclosure includes: a first filter that transmits a portion of incident light that has a first dominant wavelength; a second filter that transmits a portion of the incident light that has a second dominant wavelength different from the first dominant wavelength; an illuminance detector that detects a first illuminance of light transmitted through the first filter and a second illuminance of light transmitted through the second filter; and a controller that adjusts the luminance of an image display on a display device according to the first illuminance and the second illuminance detected by the illuminance detector.

According to this aspect, since the luminance is adjusted based on the illuminances of portions of light having different dominant wavelengths, the luminance of the image display can be adjusted according to the dominant wavelengths.

The first dominant wavelength is closer to the wavelength of a green color compared to the second dominant wavelength, and the second dominant wavelength is closer to the wavelength of a blue color compared to the first dominant wavelength. In this case, since the first dominant wavelength is set to be close to the wavelength of a green color and the second dominant wavelength is set to be close to the wavelength of a blue color, it is possible to set luminance that is suitable for each occasion of clear weather and cloudy weather.

The first dominant wavelength may be 550 to 560 nm, and the second dominant wavelength may be 360 to 400 nm. In this case, since the first dominant wavelength is set to 550 to 560 nm and the second dominant wavelength is set to 360 to 400 nm, it is possible to set luminance that is suitable for each occasion of clear weather and cloudy weather.

The controller may reduce the luminance as the difference between the first illuminance and the second illuminance increases. In this case, since the luminance is reduced as the difference between the first illuminance and the second illuminance becomes larger, the luminance can be reduced in cloudy weather.

Another aspect of the present disclosure relates to a display system. This display system includes: a display device that is mountable in a vehicle; and a luminance adjustment system that adjusts the luminance of an image display on the display device. A luminance adjustment system includes: a first filter that transmits a portion of incident light that has a first dominant wavelength; a second filter that transmits a portion of the incident light that has a second dominant wavelength different from the first dominant wavelength; an illuminance detector that detects a first illuminance of light transmitted through the first filter and a second illuminance of light transmitted through the second filter; and a controller that adjusts the luminance according to the first illuminance and the second illuminance detected by the illuminance detector.

Described above is an explanation on the present disclosure based on the embodiment. The embodiment is intended to be illustrative only, and it will be understood by those skilled in the art that various modifications to constituting elements and processes of the embodiment could be developed and that such modifications are also within the scope of the present disclosure.

While various embodiments have been described herein above, it is to be appreciated that various changes in form and detail may be made without departing from the spirit and scope of the invention(s) presently or hereafter claimed.

### CROSS-REFERENCE TO RELATED APPLICATION

This application is based upon and claims the benefit of priority from the prior Japanese Patent Application No. 2020-196280, filed on Nov. 26, 2020, the entire contents of which are incorporated herein by reference.

What is claimed is:

1. A luminance adjustment system comprising:
a first filter that transmits a portion of incident light that has a first dominant wavelength;
a second filter that transmits a portion of the incident light that has a second dominant wavelength different from the first dominant wavelength;
an illuminance detector that detects a first illuminance of light transmitted through the first filter and a second illuminance of light transmitted through the second filter; and
a controller that adjusts the luminance of an image display on a display device according to the first illuminance and the second illuminance detected by the illuminance detector.

2. The luminance adjustment system according to claim 1, wherein
the first dominant wavelength is closer to the wavelength of a green color compared to the second dominant wavelength, and
the second dominant wavelength is closer to the wavelength of a blue color compared to the first dominant wavelength.

3. The luminance adjustment system according to claim 2, wherein
the first dominant wavelength is 550 to 560 nm; and
the second dominant wavelength is 360 to 400 nm.

4. The luminance adjustment system according to claim 2, wherein the controller reduces the luminance as the difference between the first illuminance and the second illuminance increases.

5. The luminance adjustment system according to claim 3, wherein the controller reduces the luminance as the difference between the first illuminance and the second illuminance increases.

6. A display system comprising:
a display device that is mountable in a vehicle; and
a luminance adjustment system that adjusts the luminance of an image display on the display device, wherein
the luminance adjustment system includes:
a first filter that transmits a portion of incident light that has a first dominant wavelength;
a second filter that transmits a portion of the incident light that has a second dominant wavelength different from the first dominant wavelength;
an illuminance detector that detects a first illuminance of light transmitted through the first filter and a second illuminance of light transmitted through the second filter; and
a controller that adjusts the luminance according to the first illuminance and the second illuminance detected by the illuminance detector.

7. The display system according to claim 6, wherein
the first dominant wavelength is closer to the wavelength of a green color compared to the second dominant wavelength, and
the second dominant wavelength is closer to the wavelength of a blue color compared to the first dominant wavelength.

8. The display system according to claim 7, wherein
the first dominant wavelength is 550 to 560 nm; and
the second dominant wavelength is 360 to 400 nm.

9. The display system according to claim 7, wherein the controller reduces the luminance as the difference between the first illuminance and the second illuminance increases.

10. The display system according to claim 8, wherein the controller reduces the luminance as the difference between the first illuminance and the second illuminance increases.
